(19) United States
(12) Patent Application Publication
(10) Pub. No.: US 2013/0201903 A1
(43) Pub. Date: Aug. 8, 2013

(54) CONNECTION METHOD AND RADIO BASE STATION

(71) Applicants: Hideaki Takahashi, Chiyoda-ku (JP); Satoshi Nagata, Chiyoda-ku (JP); Mikio Iwamura, Chiyoda-ku (JP)

(72) Inventors: Hideaki Takahashi, Chiyoda-ku (JP); Satoshi Nagata, Chiyoda-ku (JP); Mikio Iwamura, Chiyoda-ku (JP)

(73) Assignee: NTT DOCOMO, INC., Tokyo (JP)

(21) Appl. No.: 13/817,325

(22) PCT Filed: Aug. 11, 2011
(86) PCT No.: PCT/JP2011/068386

§ 371 Date: Apr. 22, 2013

(30) Foreign Application Priority Data
Aug. 16, 2010 (JP) 2010-181875

(51) Int. Cl. H04W 16/26

(52) U.S. Cl. CPC H04W 16/26
USPC 370/315

(57) ABSTRACT

A connection method, in which a relay node RN is connected to a radio base station DeNB, includes a step of notifying, by the radio base station DeNB, the relay node RN of at least one of PCI and PRACH-Config used in a cell subordinate to the relay node RN, transmission power, a bandwidth, and TAC of RS in the relay node RN, and reception Noise Figure in the relay node RN.

### TECHNICAL FIELD

The present invention relates to a connection method and a radio base station.

### BACKGROUND ART

In an LTE (Long Term Evolution)-Advanced scheme, it is possible to use a relay node RN connectable to a radio base station DeNB (Doner eNB) through a Un interface.

The relay node RN is configured to perform radio communication with the radio base station DeNB through the Un interface, and to perform radio communication with a mobile station UE through an RN-Uu interface.

### CITATION LIST

### Non Patent Literature

[NPL 1] 3GPP TS36.300 (V10.0.0), “Evolved Universal Terrestrial Radio Access (E-UTRA) and Evolved Universal Terrestrial Radio Access Network (E-UTRAN) Physical Channels”, June, 2010

[NPL 2] 3GPP TR36.814 (V9.0.0), “Further Advancements for E-UTRA Physical Layer Aspects”, March, 2010

[NPL 3] 3GPP TS36.331 (V9.3.0), “Radio Resource Control (RRC); Protocol specification”, June, 2010

### SUMMARY OF INVENTION

### Technical Problem

Furthermore, in the LTE-Advanced scheme, it is considered that a communication provider sets a parameter, which is used in a cell subordinate to a relay node, using an O & M (Operation & Maintenance) server.

However, the relay node RN is considered to be installed for the purpose of expansion and the like of a coverage area, and it is also probable that the number of relay nodes RN to be installed is enormous.

Therefore, it is probable that it is difficult for a communication provider to set parameters used in cells subordinate to all relay nodes RN.

Furthermore, the parameters need to be set in consideration of an interference situation around the relay nodes RN, and parameters used in radio base stations eNB/DeNB around the relay nodes RN or parameters used in the relay nodes RN, and it is difficult for the communication provider to set the parameters used in the cells subordinate to all the relay nodes RN in consideration of the situation.

Therefore, the present invention has been achieved in view of the above-described problems, and an object thereof is to provide a connection method and a radio base station, by which it is possible to determine a parameter used in a cell subordinate to a relay node RN in consideration of a peripheral situation.

### Solution to Problem

A first characteristic of the present embodiment is summarized in that a connection method, in which a relay node is connected to a radio base station, includes: a step of notifying, by the radio base station, the relay node of at least one of PCI and setup information of a physical random access channel used in a cell subordinate to the relay node, transmission power, a bandwidth, and a tracking area code of a reference signal in the relay node, and reception noise figure in the relay node.

A second characteristic of the present embodiment is summarized in that a radio base station, to which a relay node is connectable, includes: a notification unit that notifies the relay node of at least one of PCI and setup information of a physical random access channel used in a cell subordinate to the relay node, transmission power, a bandwidth, and a tracking area code of a reference signal in the relay node, and reception noise figure in the relay node in a connection procedure between the relay node and the radio base station.

### Advantageous Effects of Invention

As described above, according to the present invention, it is possible to provide a connection method and a radio base station, by which it is possible to determine a parameter used in a cell subordinate to a relay node RN in consideration of a peripheral situation.

### BRIEF DESCRIPTION OF DRAWINGS

FIG. 1 is a diagram illustrating the entire configuration of a mobile communication system according to a first embodiment of the present invention.

FIG. 2 is a functional block diagram of a radio base station according to the first embodiment of the present invention.

FIG. 3 is a diagram illustrating an example of “PRACH-Config” used in the mobile communication system according to the first embodiment of the present invention.

FIG. 4 is a sequence diagram illustrating operations in the mobile communication system according to the first embodiment of the present invention.

FIG. 5 is a flowchart illustrating the operations in the mobile communication system according to the first embodiment of the present invention.

### DESCRIPTION OF EMBODIMENTS

(Mobile Communication System According to First Embodiment of the Present Invention)

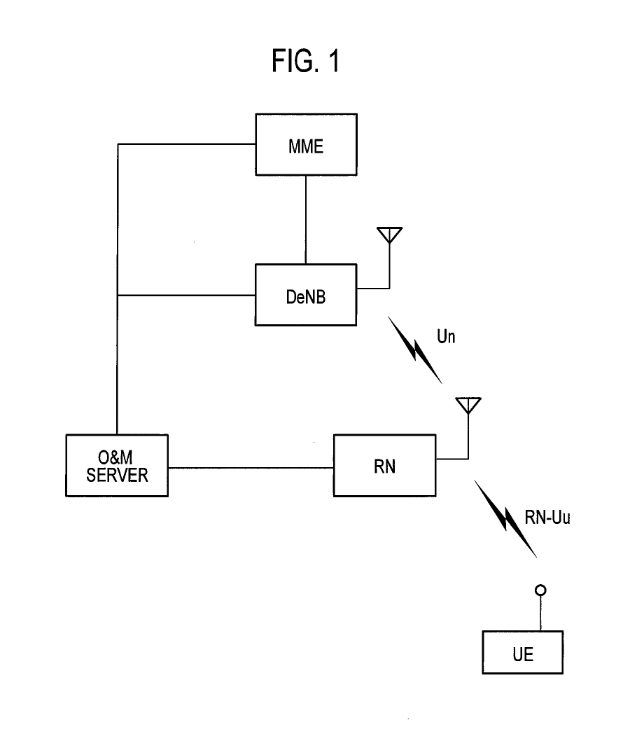

A mobile communication system according to a first embodiment of the present invention is described with reference to FIG. 1 through FIG. 5.

The mobile communication system according to the present embodiment is an LTE-Advanced mobile communication system, and includes a mobility management node MME (Mobility Management Entity), a radio base station DeNB, a relay node RN, and an O&M (Operation & Maintenance) server as illustrated in FIG. 1.

The relay node RN is configured to perform radio communication with the radio base station DeNB through a Un interface, and perform radio communication with a mobile station UE through a Uu interface.

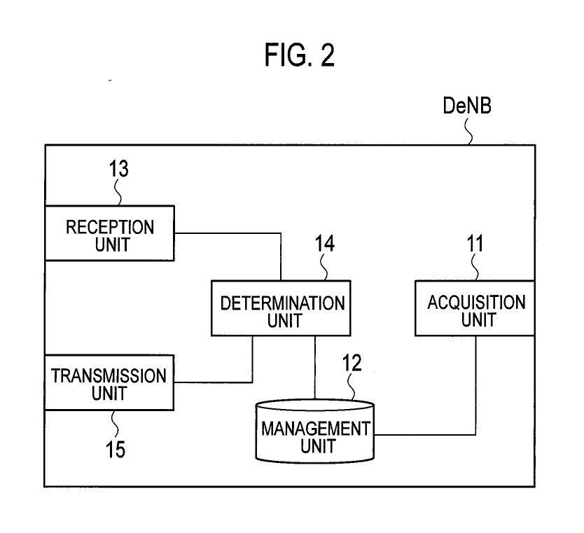

As illustrated in FIG. 2, the radio base station DeNB includes an acquisition unit 11, a management unit 12, a reception unit 13, a determination unit 14, and a transmission unit 15.

The acquisition unit 11 is configured to acquire a predetermined parameter used in a peripheral radio base station eNB/DeNB or relay node RN from the peripheral radio base station eNB/DeNB through an X2 interface.

For example, the acquisition unit 11 is configured to acquire, as the predetermined parameter, PCI (Physical Cell Identity), PRACH-Config, a bandwidth, TAC (Tracking Area code) and the like which are used in a cell subordinate to the peripheral radio base station eNB/DeNB or relay node RN.

Furthermore, the acquisition unit 11 is configured to acquire, as the predetermined parameter, an interference amount in the cell subordinate to the peripheral radio base station eNB/DeNB or relay node RN.

The acquisition unit 11 is able to acquire the aforementioned predetermined parameter (including the interference amount), which is used in the cell subordinate to the peripheral radio base station eNB/DeNB or relay node RN, using “X2 Application Protocol (refer to TS36.423 specifications)” except for the TAC.

The management unit 12 is configured to manage the predetermined parameter acquired by the acquisition unit 11.

The reception unit 13 is configured to receive a message, which is transmitted by the relay node RN or the mobility management node MME, in a connection procedure between the relay node RN and the radio base station DeNB.

For example, the reception unit 13 is configured to acquire capability information of the relay node RN, such as a bandwidth supported in a radio zone (hereinafter, referred to as a Un radio zone) in which the Un interface is used, a bandwidth supported in a radio zone (hereinafter, referred to as an RN-Uu radio zone) in which an RN-Uu interface is used, information regarding whether “Half Duplex inband relay (Type 1 relay)” is supported, or information regarding whether “Full Duplex inband relay (Type 1b relay)” is supported, from the relay node RN through “RRC RN (UE) Capability Information” in the connection procedure between the relay node RN and the radio base station DeNB.

Furthermore, the “Half Duplex inband relay” is an operation of time-dividing a transmission timing in the RN-Uu radio zone and a reception timing in the Un radio zone using the same carrier frequency and bandwidth in the RN-Uu radio zone and the Un radio zone in the relay node RN.

Meanwhile, the “Full Duplex inband relay” is an operation of not time-dividing the transmission timing in the RN-Uu radio zone and the reception timing in the Un radio zone using the same carrier frequency and bandwidth in the RN-Uu radio zone and the Un radio zone in the relay node RN.

The relay node RN supporting the “Full Duplex inband relay” includes a high performance filter, or is a high performance relay node RN that spatially divides a transmission antenna and a reception antenna.

In addition, an “outband relay” is an operation using different carrier frequencies and bandwidths in the RN-Uu radio zone and the Un radio zone in the relay node RN.

The determination unit 14 is configured to determine PCI and PRACH-Config used in the cell subordinate to the relay node RN, transmission power, a bandwidth, and TAC of RS (Reference Signal) in the relay node RN, reception Noise Figure in the relay node RN, and the like, based on the aforementioned predetermined parameter managed by the management unit 12, the aforementioned capability information of the relay node RN, and the like.

Furthermore, the determination unit 14 is configured to determine the “outband relay”, the “Half Duplex inband relay”, or the “Full Duplex inband relay”, which is to be used in the relay node RN, based on the aforementioned capability information of the relay node RN, a bandwidth available in the Un radio zone acquired from the O&M server, and the like.

Moreover, the determination unit 14 may be configured to determine a carrier frequency and a bandwidth, which are used in the RN-Uu radio zone, based on the aforementioned capability information of the relay node RN, the bandwidth available in the Un radio zone acquired from the O&M server, and the like.

The transmission unit 15 is configured to transmit a predetermined message to the relay node RN and the mobility management node MME in the connection procedure between the relay node RN and the radio base station DeNB.

For example, the transmission unit 15 is configured to notify the relay node RN of at least one of the PCI and the PRACH-Config used in the cell subordinate to the relay node RN, the transmission power, the bandwidth, and the TAC of the RS in the relay node RN, and the reception Noise Figure in the relay node RN through “RRC Connection Reconfiguration” in the connection procedure between the relay node RN and the radio base station DeNB.

Furthermore, the transmission unit 15 may be configured to notify the relay node RN of at least one of the PCI and the PRACH-Config used in the cell subordinate to the relay node RN, the transmission power, the bandwidth, and the TAC of the RS in the relay node RN, and the reception Noise Figure in the relay node RN through a newly defined RRC message.

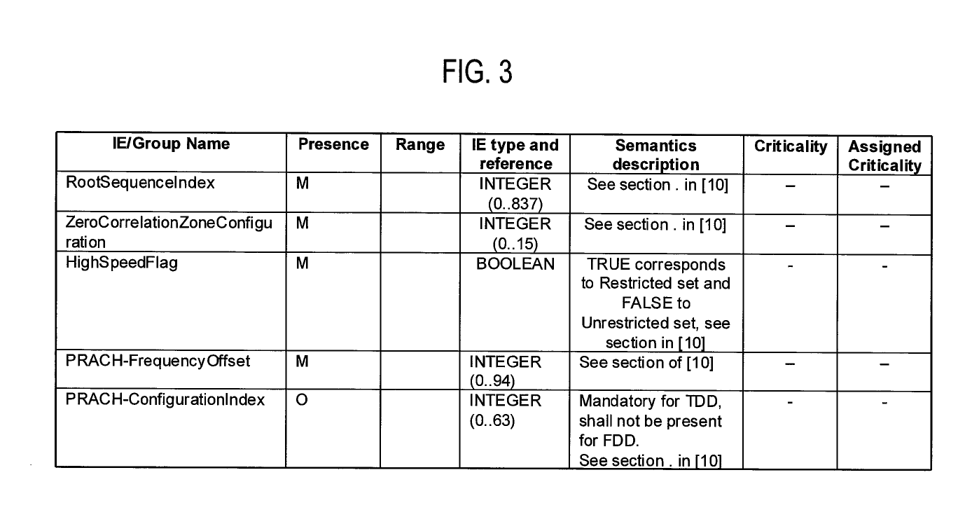

FIG. 3 illustrates an example of the PRACH-Config.

Furthermore, the transmission unit 15 may be configured to notify the relay node RN of the carrier frequency and the bandwidth, which are used in the RN-Uu radio zone, through the “RRC Connection Reconfiguration” in the connection procedure between the relay node RN and the radio base station DeNB.

Furthermore, the transmission unit 15 may be configured to notify the relay node RN of the carrier frequency and the bandwidth, which are used in the RN-Uu radio zone, through the newly defined RRC message.

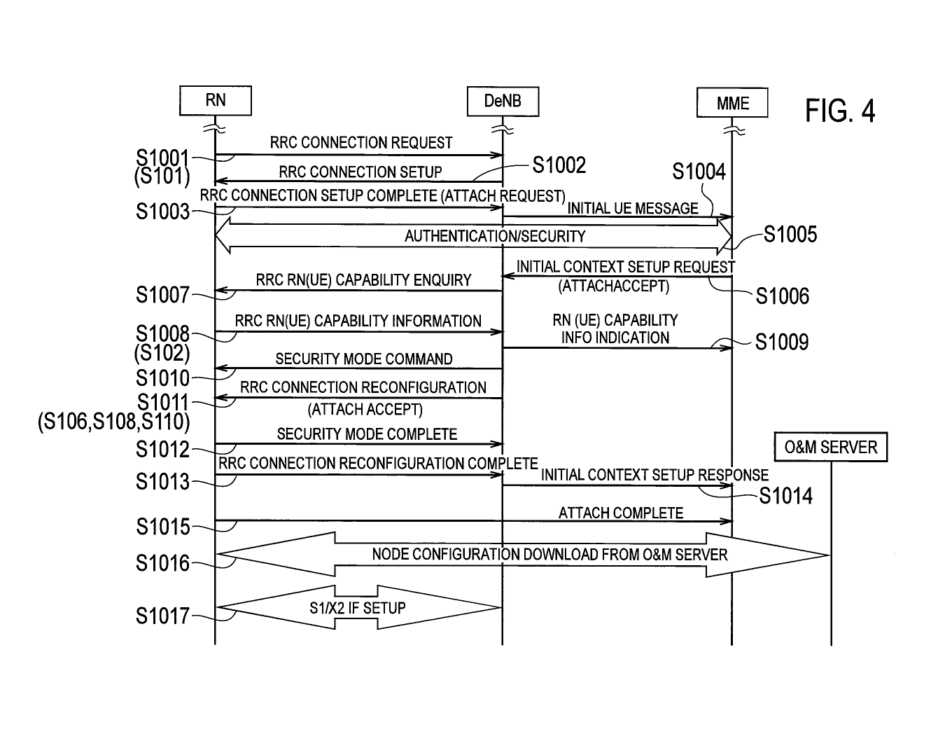

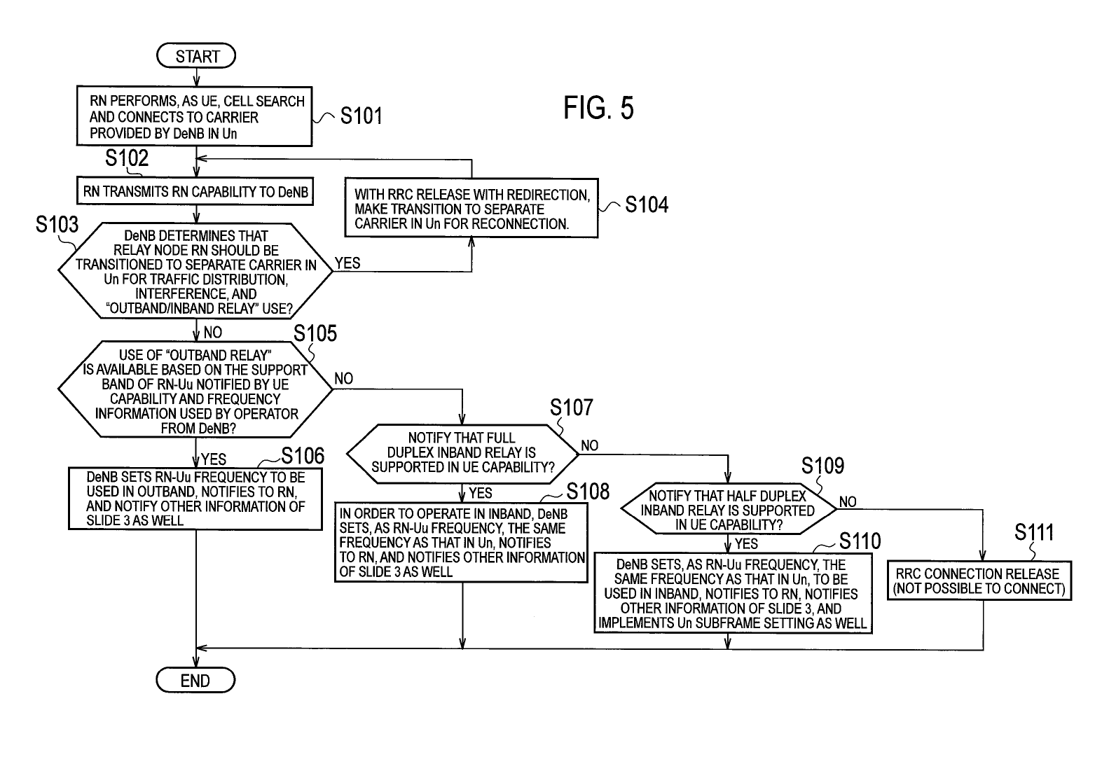

The connection procedure between the relay node RN and the radio base station DeNB in the mobile communication system according to the present first embodiment is described with reference to FIG. 4 and FIG. 5 below.

As illustrated in FIG. 4 and FIG. 5, in step S1001 (S101), the relay node RN performs a cell search process, selects a carrier provided by the radio base station DeNB in the Un radio zone, and transmits “RRC Connection Request” to the radio base station DeNB, similarly to the function of the mobile station UE.

In step S1002, the radio base station DeNB transmits “RRC Connection Setup” to the relay node RN.

In step S1003, the relay node RN transmits “RRC Connection Setup Complete” including “Attach Request” to the radio base station DeNB.

In step S1004, the radio base station DeNB transmits “Initial UE Message” to the mobility management node MME.

In step S1005, an “Authentication/Security” process is performed.

In step S1006, the mobility management node MME transmits “Initial Context Setup Request” including “Attach Accept” to the radio base station DeNB.

In step S1007, the radio base station DeNB transmits “RRC UE (RN) Capability Enquiry” to the relay node RN.

In step S1008, the relay node RN transmits “RRC UE (RN) Capability Information” to the radio base station DeNB.

In step S1009, the radio base station DeNB transmits “UE (RN) Capability Info Indication” to the mobility management node MME.

The radio base station DeNB transmits “Security Mode Command” to the relay node RN in step S1010, and transmits “RRC Connection Reconfiguration” including the “Attach Accept” to the relay node RN in step S1011.

Furthermore, when the “RRC UE (RN) Capability Information” is received, the radio base station DeNB determines whether to allow the relay node RN to be transitioned to a separate carrier in the Un radio zone in order to distribute traffic or reduce an interference amount or to perform the “outband relay” or the “inband relay” in step S103 as illustrated in FIG. 5.

In the case of “Yes”, the present operation proceeds to step S104, and in the case of “No”, the present operation proceeds to step S105.

In step S104, the radio base station DeNB transmits “RRC Release with Redirection” to the relay node RN, thereby allowing the relay node RN to be transitioned to a separate carrier. Then, the present operation returns to step S102.

Meanwhile, in step S105, the radio base station DeNB determines whether it is possible to use the “outband relay” in the relay node RN based on the aforementioned capability information of the relay node RN, the bandwidth available in the Un radio zone acquired from the O&M server, and the like.

In the case of “Yes”, the present operation proceeds to step S106, and in the case of “No”, the present operation proceeds to step S107.

In step S106 (step S1011), the radio base station DeNB determines a carrier frequency and a bandwidth to be used in the RN-Uu radio zone, and allows the carrier frequency and the bandwidth to be included in the “RRC Connection Reconfiguration”, in order to perform the “outband relay”.

Furthermore, the radio base station DeNB may also allow at least one of the PCI and the PRACH-Config used in the cell subordinate to the relay node RN, the transmission power, the bandwidth, and the TAC of the RS (Reference Signal) in the relay node RN, and the reception Noise Figure in the relay node RN, which were determined as described above, to be included in the “RRC Connection Reconfiguration”.

Furthermore, in step S107, the radio base station DeNB determines whether it is possible to use the “Full Duplex inband relay” in the relay node RN based on the aforementioned capability information of the relay node RN, and the like.

In the case of “Yes”, the present operation proceeds to step S108, and in the case of “No”, the present operation proceeds to step S109.

In step S108 (step S1011), the radio base station DeNB allows a carrier frequency and a bandwidth, which are equal to the carrier frequency and the bandwidth used in the Un radio zone, to be included in the “RRC Connection Reconfiguration” as the carrier frequency and the bandwidth used in the RN-Uu radio zone, in order to perform the “Full Duplex inband relay”.

Furthermore, the radio base station DeNB may also allow at least one of the PCI and the PRACH-Config used in the cell subordinate to the relay node RN, the transmission power, the bandwidth, and the TAC of the RS (Reference Signal) in the relay node RN, and the reception Noise Figure in the relay node RN, which were determined as described above, to be included in the “RRC Connection Reconfiguration”.

Furthermore, in step 5109, the radio base station DeNB determines whether it is possible to use the “Half Duplex inband relay” in the relay node RN based on the aforementioned capability information of the relay node RN, and the like.

In the case of “Yes”, the present operation proceeds to step S110, and in the case of “No”, the present operation proceeds to step S111.

In step S110 (step S1011), the radio base station DeNB allows a carrier frequency and a bandwidth, which are equal to the carrier frequency and the bandwidth used in the Un radio zone, to be included in the “RRC Connection Reconfiguration” as the carrier frequency and the bandwidth used in the RN-Uu radio zone, in order to perform the “Half Duplex inband relay”.

Furthermore, the radio base station DeNB may also allow at least one of the PCI and the PRACH-Config used in the cell subordinate to the relay node RN, the transmission power, the bandwidth, and the TAC of the RS (Reference Signal) in the relay node RN, and the reception Noise Figure in the relay node RN, which were determined as described above, to be included in the “RRC Connection Reconfiguration”.

Furthermore, the radio base station DeNB may also perform setup of an MBSFN (MBMS Single Frequency Network) subframe in the RN-Uu radio zone, and may allow a result of the setup to be included in the “RRC Connection Reconfiguration”.

In addition, the radio base station DeNB may also allow the result of the setup to be included in the newly defined RRC message for transmission, instead of the “RRC Connection Reconfiguration”.

The relay node RN transmits “Security Mode Complete” to the radio base station DeNB in step S1012, and transmits “RRC Connection Reconfiguration Complete” to the radio base station DeNB in step S1013.

In step S1014, the radio base station DeNB transmits “Initial Context Setup Response” to the mobility management node MME.

In step S1015, the relay node RN transmits “Attach Complete” to the mobile management node MME.

In step S1016, the relay node RN downloads setup information (Node Configuration) from the O&M server.

In step S1017, the relay node RN establishes S1/X2 interfaces with the radio base station DeNB.

In accordance with the mobile communication system according to the present embodiment, the radio base station DeNB is able to set a parameter used in the cell subordinate to the relay node RN in consideration of a peripheral situation and the like.

The characteristics of the present embodiment as described above may be expressed as follows.

A first characteristic of the present embodiment is summarized in that a connection method, in which a relay node RN is connected to a radio base station DeNB, includes: a step of notifying, by the radio base station DeNB, the relay node RN of at least one of PCI and PRACH-Config (setup information of a physical random access channel) used in a cell subordinate to the relay node RN, transmission power, a bandwidth, and TAC (Tracking Area Code) of RS (Reference Signal) in the relay node RN, and reception Noise Figure in the relay node RN.

A second characteristic of the present embodiment is summarized in that a radio base station DeNB, to which a relay node RN is connectable, includes: a transmission unit 15 (a notification unit) configured to transmit “RRC Connection Reconfiguration” or a newly defined RRC message to the relay node RN in a connection procedure between the relay node RN and the radio base station DeNB, the “RRC Connection Reconfiguration” or the newly defined RRC message notifying at least one of PCI and PRACH-Config (setup information of a physical random access channel) used in a cell subordinate to the relay node RN, transmission power, a bandwidth, and TAC (Tracking Area Code) of RS (Reference Signal) in the relay node RN, and reception Noise Figure in the relay node RN.

Note that the operation of the mobile management node MME, the radio base station DeNB, the relay node RN, or the mobile station UE may be performed by hardware, a software module performed by a processor, or a combination thereof.

The software module may be arranged in a storage medium of an arbitrary format such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can write and read information into and from the storage medium. Such a storage medium may also be accumulated in the processor. Such a storage medium and processor may be arranged in an ASIC. Such an ASIC may be arranged in the mobile management node MME, the radio base station DeNB, the relay node RN, or the mobile station UE. Furthermore, such a storage medium and processor may be arranged in the mobile management node MME, the radio base station DeNB, the relay node RN, or the mobile station UE as discrete components.

Thus, the present invention has been explained in detail by using the above-described embodiments; however, it is obvious that for persons skilled in the art, the present invention is not limited to the embodiments explained herein. The present invention can be implemented as a corrected and modified mode without departing the gist and the scope of the present invention defined by the claims. Therefore, the description of the specification is intended for explaining the example only and does not impose any limited meaning to the present invention.

### REFERENCE SIGNS LIST

UE . . . Mobile station
MME . . . Mobile management node
RN . . . Relay node
DeNB . . . Radio base station
11 . . . acquisition unit
12 . . . management unit
13 . . . reception unit
14 . . . determination unit
15 . . . transmission unit

1. A connection method, in which a relay node is connected to a radio base station, comprising:
a step of notifying, by the radio base station, the relay node of at least one of PCI and setup information of a physical random access channel used in a cell subordinate to the relay node, transmission power, a bandwidth, and a tracking area code of a reference signal in the relay node, and reception noise figure in the relay node.

2. The connection method according to claim 1, wherein, in the notifying step, the radio base station performs the notification through an RRC message.

3. A radio base station, to which a relay node is connectable, comprising:
a notification unit that notifies the relay node of at least one of PCI and setup information of a physical random access channel used in a cell subordinate to the relay node, transmission power, a bandwidth, and a tracking area code of a reference signal in the relay node, and reception noise figure in the relay node in a connection procedure between the relay node and the radio base station.

4. The radio base station according to claim 3, wherein the notification unit is configured to perform the notification through an RRC message.
